(19) United States
(12) Patent Application Publication
(10) Pub. No.: US 2009/0125425 A1
(43) Pub. Date: May 14, 2009

(54) AUDITABLE MERCHANDISE DELIVERY USING AN ELECTRONIC BILL OF LADING

(75) Inventors: David D. Kloostra, Edwardsville, IL (US); Curtis Miller, St. Louis, MO (US)

Correspondence Address: Patent Docket Department;Armstrong Teasdale LLP, One Metropolitan Square, Suite 2600, St. Louis, MO, 63102-2740, US

(73) Assignee: HUNTER E. RILEY, LLC, Edwardsville, IL (US)

(21) Appl. No.: 12/262,948

(22) Filed: Oct. 31, 2008

Related U.S. Application Data
(60) Provisional application No. 60/984,643, filed on Nov. 1, 2007.

(51) Int. Cl. G06Q 10/00; G01C 21/00; G06Q 50/00

(52) U.S. Cl. 705/29; 701/300

(57) ABSTRACT

A method for auditable tracking of a shipment is described. The method includes providing instructions for execution on a server and for execution on a mobile device. The instructions for execution on the server include at least one code segment configured to: receive a request from a shipper to ship a plurality of goods, receive logistics information from a logistics company in response to the request form the shipper, receive from the shipper a bill of lading (BOL), and receive from the logistics company data identifying a quantity of the plurality of goods that was delivered. The instructions for execution on the mobile device include at least one code segment configured to: enable a user to edit the BOL responsive to an inspection by the user of the delivered plurality of goods, and provide the edited BOL to the server, the shipper, and the logistics company.

### CROSS REFERENCE TO RELATED APPLICATIONS

This application claims the benefit of U.S. Provisional Patent Application Ser. No. 60/984,643, filed on Nov. 1, 2007 titled “Auditable Merchandise Delivery Using An Electronic Bill of Lading,” which is hereby incorporated by reference in its entirety.

### BACKGROUND

Traditionally, the supply chain process of packaging and preparing a shipment to a receiver is performed by a product manufacturer or shipper. The product manufacturer, on receiving an order confirmation from a customer, establishes contact with a shipping company that performs the actual shipping. However, once the shipment has been received by the shipping company, it is susceptible to innumerable risks. For instance, delayed shipment of products by the shipping company can result in lost sales and accumulated back orders. In addition, the products may be lost, stolen, or damaged in transit that lead to anguish, both on the part of the product manufacturer and the receiver. Existing systems fail to provide efficient shipment tracking and auditing in the supply chain process between the manufacturer and receiver.

### BRIEF DESCRIPTION

In one aspect, a method for auditable tracking of a shipment is provided. The method includes providing computer-executable instructions for execution on a server and providing computer-executable instructions for execution on a mobile device. The computer-executable instructions for execution on the server include at least one code segment configured to: receive a request from a shipper to ship a plurality of goods, receive logistics information from a logistics company in response to the request from the shipper, receive from the shipper a bill of lading associated with the plurality of goods, and receive from the logistics company data identifying a quantity of the plurality of goods delivered. The computer-executable instructions for execution on the mobile device include at least one code segment configured to: facilitate editing of the bill of lading responsive to an inspection by the user of the delivered plurality of goods, and provide the edited bill of lading to the server, the shipper, and the logistics company.

In another aspect, an auditable tracking system is provided. The auditable tracking system includes a server and a mobile device. The server is configured to: receive a request from a shipper to ship a plurality of goods, receive a confirmation from a logistics company accepting the shipment request, and receive a bill of lading from the shipper. The mobile device is configured to: receive information corresponding to receipt of the plurality of goods at a delivery destination, edit the bill of lading in accordance with the information corresponding to receipt of the plurality of goods at the delivery destination, and provide the edited bill of lading to the server, the shipper, and the logistics company.

### BRIEF DESCRIPTION OF THE DRAWINGS

FIG. 1 is a block diagram of an exemplary auditable tracking system, and an exemplary communication flow pattern between the tracking system and a shipment source, a receiver, and a logistics company.

FIG. 2 is a flowchart of an exemplary method for auditable tracking of a shipment.

FIG. 3 is a flowchart illustrating steps included in ordering a shipment.

FIG. 4 is a flowchart illustrating steps included in monitoring the shipment.

FIG. 5 is a flowchart illustrating steps included in auditing delivery of the shipment.

FIG. 6 is a block diagram illustrating an exemplary flow of information during completion of a shipment using the auditable tracking system shown in FIG. 1.

FIG. 7 is a block diagram illustrating another exemplary flow of information during completion of a shipment using the auditable tracking system shown in FIG. 1.

FIGS. 8-12 are exemplary schemas for storing data in the server of the auditable tracking system shown in FIG. 1.

### DETAILED DESCRIPTION

In one aspect, an auditable tracking system described herein facilitates interfacing between a shipment source that requires a shipment, a logistics company that performs actions associated with actual shipment, and a receiver who requests a product from the shipment source. In other aspects, the auditable tracking system described herein facilitates real-time tracking or near real-time tracking and audit of the shipment from the time when shipment is initiated at the shipment source to a time when shipment is actually delivered to the receiver. Other aspects facilitate auditing the shipment products in real-time as they are unloaded from a truck and delivered to the receiver to ensure product accuracy and product condition.

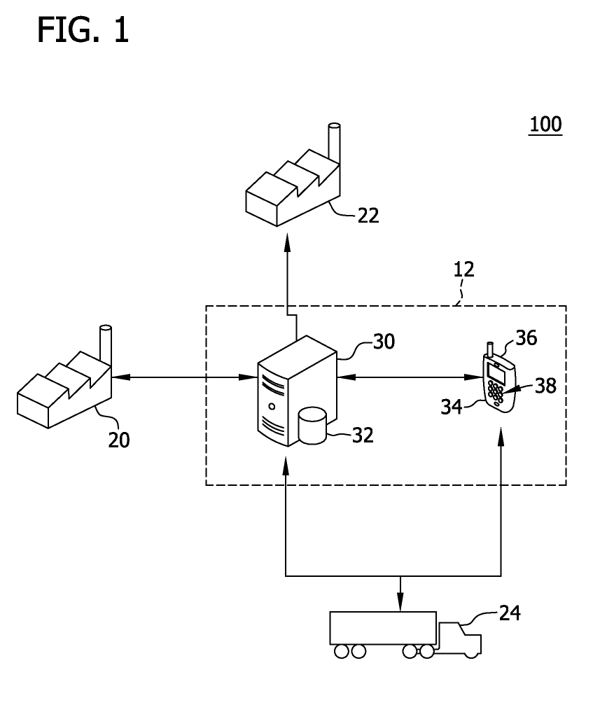

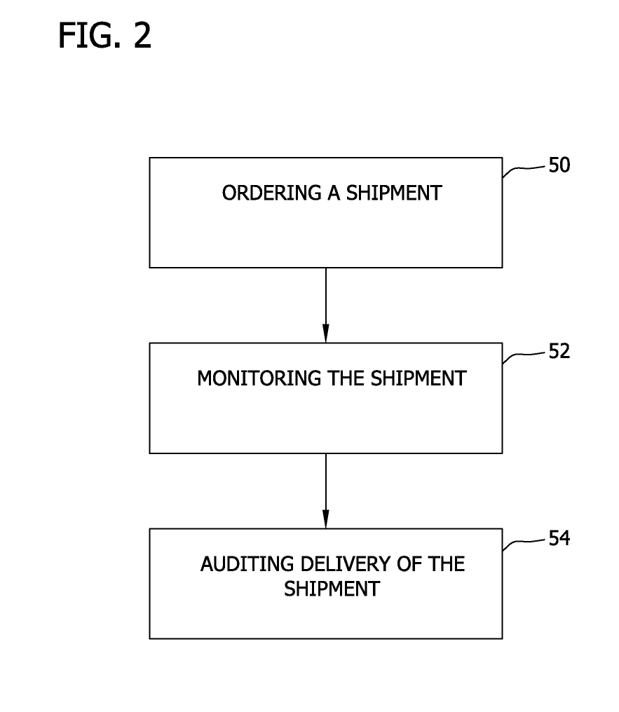

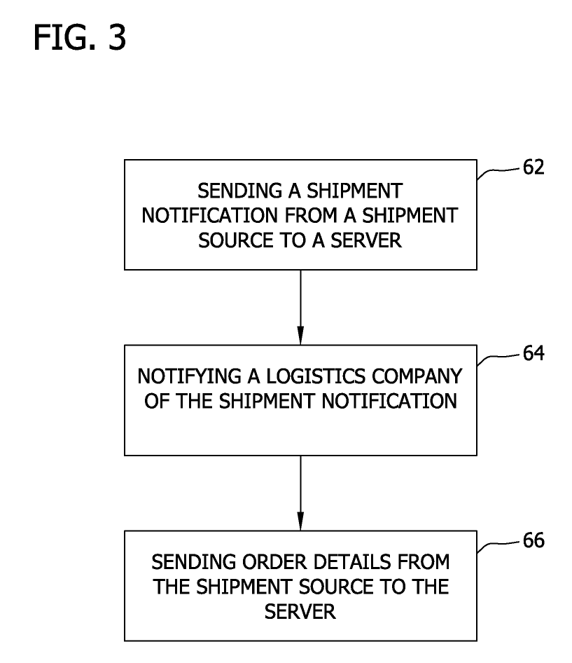

FIG. 1 is a block diagram 100 of an exemplary auditable tracking system 12, and an exemplary communication flow pattern between the tracking system 12 and a shipment source 20, a receiver 22, and a logistics company 24. Furthermore, referring to FIG. 1, FIG. 2, and FIG. 3, an embodiment of the tracking system 12 interfaces between the shipment source 20, the logistics company 24, and the receiver 22 to facilitate providing shipment related information to the various parties. In the exemplary embodiment, tracking system 12 includes a server 30 and a database 32. Database 32 is coupled to server 30 and configured to communicate with shipment source 20, receiver 22, and logistics company 24. Furthermore, in the exemplary embodiment, tracking system 12 includes a mobile device 34. In some embodiments, mobile device 34 is a smart phone hand held device, however, mobile device 34 may be any type of mobile hand held device that facilitates operation of system 12 as described herein. Mobile device 34 may include, or may be coupled to, a scanning device 36. Scanning device 36 is configured to obtain information presented in a bar code, or any other type of code, printed on an item. Mobile device 34 may also include a keypad 38 configured to facilitate user entry of information into mobile device 34. In the exemplary embodiment, database 32 is coupled to mobile device 34.

In some embodiments, database 32 (or other memory area) includes a structured query language (SQL) database configured to store information for reporting to logistics company 24 regarding the whereabouts of their containers and products (not shown in FIG. 1), as well as to store transmitting information for invoicing customers. In some embodiments, shipment source 20 may be a product manufacturer who ships their own products. In other embodiments, shipment source 20 may be a company outsourced by a product manufacturer, a warehouse or storage location from which the product manufacturer ships their products, or a distributor hired by the product manufacturer to distribute products. Although referred to herein as logistics company 24, logistics company 24 may also be a logistics service or any other individual or organization that provides logistical support.

FIG. 2 is a flowchart of an exemplary method for auditable tracking of a shipment. In an exemplary embodiment, auditable tracking system 12 (shown in FIG. 1) is configured to perform the auditable tracking method. The method includes ordering 50 a shipment, monitoring 52 the shipment, and auditing 54 delivery of the shipment.

FIG. 3 is a flowchart of steps included in ordering 50 the shipment. In an exemplary embodiment, ordering 50 includes sending 62 a shipment notification from shipment source 20 to server 30 (shown in FIG. 1). The shipment notification includes a request from shipment source 20 that a shipment be made to receiver 22. In an exemplary embodiment, personnel at shipping source 20 send the notification to server 30, however, the notification may also be sent automatically. In some embodiments, shipment source 20 personnel may contact server 30 via a web portal. In an alternate embodiment, shipment source 20 personnel may contact server 30 via other communication channels such as telephone, e-mail, fax, or any other communication media. The notification to server 30 may be in the form of a spreadsheet, a word processing document, an electronic data interchange (EDI) message such as an advanced ship notice, or an entry into a web service portal associated with server 30.

In an exemplary embodiment, the data included in the notification, which is supplied from shipment source 20 to database 32, is divided into three sections. Although three sections are described, any number of sections may be incorporated with details pertaining to the shipment source and/or to relevant shipment information. In an exemplary embodiment, a first section includes shipment source information, a second section includes actual shipment information, and a third section includes shipment order information.

More specifically, the first section may include shipment source information including a ship from name, a ship from street, a ship from city, a ship from state, a ship from zip, and a ship from phone number that are supplied from shipment source 20 to database 32. Furthermore, a shipment company name, shipment personnel name, and a digital signature may be further included to validate the identity of shipper 20.

In an exemplary embodiment, the actual shipment information included in the second section may be supplied from shipment source 20 to database 32. In some embodiments, actual shipment information may include one or more of, a shipment number, a trailer size, a hazmat designation, a ship date and time, a load date and time, a planned shipment in cases, a planned shipment in cubes, a planned shipment in pallets, a planned ship weight, a planned unit of weight (Kg/Lb), a master bill of lading (BOL) number, a preferred carrier/logistics company, a preferred carrier contact email, and a preferred carrier phone number/contact number.

In an exemplary embodiment, the shipment order information included in the third section may be supplied from shipment source 20 to database 32. Shipment order information may include, but is not limited to, a quantity of stops, a ship to name, a ship to street, a ship to city, a ship to zip, a ship to phone number, a order number, a customer PO number, an arrival date and time, a global location number (GLN), a Dunn and Bradstreet Universal Number System (DUNS) or other location-specific business identification number), and a booking. If there is more than one shipment stop, the information for the third section may be supplied from shipment source 20 to a database for each shipping stop. It is to be understood that the sections described above are exemplary only, and additional sections and subsections may be incorporated to substantiate shipment information.

In an exemplary embodiment, if more than one shipment stop is desired in instances pertaining to more than one order, information pertaining to number of cases/pieces in an order, number of pallets in an order, number of cubes in an order, weight of an order, and number of lines on BOL/Order are to be supplied by shipper 20 to the database 32 for each order.

Ordering 50 the shipment also includes notifying 64 a logistics company of the shipment notification. For example, after the information from the above described sections is entered into database 32, logistics company 24 is notified of the shipment request for the shipment from shipment source 20 to receiver 22. In some embodiments, server 30 may contact logistics company 24 via a logistics company web portal. In alternative embodiments, server 30 may contact logistics company 24 via other communication channels such as telephone, e-mail, fax, or any other communication media. The notification to logistics company 24 is accompanied with information from the first section pertaining to the shipment source including at least a ship from name, ship from street, ship from city, ship from state, ship from zip, and ship from phone number.

In addition, logistics company 24 may also be provided with information from the second section pertaining to the actual shipment, such as, shipment number, trailer size, hazmat designation, ship date and time, load date and time, planned shipment in cases, planned shipment in cubes, planned shipment in pallets, planned ship weight, and master bill of lading (BOL) number.

Further, logistics company 24 may also be provided with information from the third section pertaining to the shipment order information including, but not limited to, a quantity of stops, ship to name, ship to street, ship to city, ship to zip, ship to phone number, order number, customer PO number, arrival date and time, GLN/DUNNS number, and booking number. If there exists more than one shipping stop, the information regarding ship to name, ship to street, ship to city, ship to zip, ship to phone number, order number, customer PO number, arrival date and time, GLN/DUNNS number, and booking number are to be supplied by the server to logistics company 24 for each shipping stop.

Furthermore, in an exemplary embodiment, if more than one shipping stop is desired in instances pertaining to more than one order, information pertaining to a quantity of cases/pieces in an order, quantity of pallets in an order, quantity of cubes in an order, weight of an order, and quantity of lines on BOL/Order are to be supplied by the server to the logistics company for each order placed.

Notifying 64 logistics company 24 of the shipment notification may also include sending an acknowledgment from logistics company 24 to server 30 indicating an awareness of the shipment order upon receiving communication from server 30. More specifically, the logistics company 24 may provide a confirmation to server 30 by, for example, sending logistics information from logistics company 24 to server 30. The logistics information may include an assigned truck driver name, an assigned smart phone number that will be loaded with software described below, and/or an assigned trailer number. In an exemplary embodiment, the trailer number is the same as the shipment number that is supplied by server 30 in the second section. The confirmation provided to server 30 may be in the form of a spreadsheet, a word processing document, an electronic data interchange (EDI) message such as an advanced ship notice, or entry into a web service portal associated with server 30.

Personnel of logistics company 24 may select a truck driver from a pull down menu contained in the server's web portal, or by directly entering the truck driver information in the form of keyboard strokes. During this process, the server 30 assigns a designated truck driver's identification number to a planned shipment order.

Ordering 50 the shipment also includes sending 66 order details from the shipment source 20 to the server 30. For example, when the shipment is ready for pick-up at shipment source 20, a bill of lading (BOL) is created by the personnel at the shipment source 20 and submitted to database 32 through the web service. In an alternate embodiment, a bill of lading may be submitted by the personnel at shipment source 20 to database 32 after the shipment has been picked-up by logistics company 24.

The bill of lading is a log record containing all the shipment data as it comes from shipment source 20 in the form of a packaging list or an electronic data interchange (EDI) message such as an advanced ship notice pertaining to a shipment order. The information contained in the bill of lading includes, but is not limited to, the shipment number, the purchase order number(s), the planned shipment date, planned shipment time, the shipment identification number, the license plate or pallet identification number for each pallet, the product UPC and description for each pallet, the quantity in units of each item of each UPC on each pallet, the invoice numbers relative to each section of the shipment, the ship-to name, the address, and the zip code.

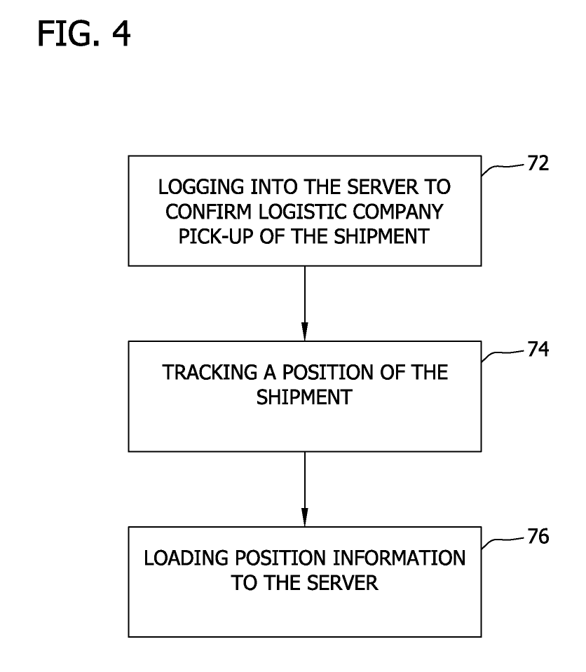

FIG. 4 is a flowchart of steps included in monitoring 52 the shipment. In the exemplary embodiment, monitoring 52 the shipment includes logging 72 into server 30 to confirm logistic company 24 pick-up of the shipment. For example, when the truck driver arrives at shipment source 20, the truck driver typically logs into database 32 via a server mobile application. This process is performed by means of a mobile hand held device, for example, mobile device 34 (shown in FIG. 1), by keying in a unique truck driver identification number. The mobile server application automatically compares the identification number keyed into mobile device 34 by the truck driver with the planned shipment truck driver identification number that was previously submitted to database 32 by logistics company 24. Comparing the keyed-in identification number to the planned shipment truck driver identification number facilitates ensuring that the appropriate truck driver has a scheduled shipment pick-up on that day. In an exemplary embodiment, if a truck driver is associated with more than one logistics company, the truck driver is provided with a list of logistics companies with whom he is associated, and an option of selecting an appropriate logistics company for whom the shipment is intended.

Moreover, when the truck driver logs into the mobile application, a unique identification number associated with mobile device 34 is transmitted to the mobile application that assigns that specific mobile device to the planned shipment order that is stored in database 32. In an exemplary embodiment, the unique identification number may be a phone number or any other device identification number associated with mobile device 34. In addition, if mobile device 34 is interchanged during the course of shipment at transit locations, the truck driver can log into the server mobile application by means of a new mobile device that automatically assigns the planned shipment order to the new mobile device. Once a particular mobile device has been assigned with a planned shipment order, the bill of lading information that was previously submitted to database 32 by the shipment source is automatically transmitted to the mobile device in the format of the mobile device in real time. In some embodiments, the mobile device is configured to operate on a WINDOWS MOBILE brand operating system such as WINDOWS MOBILE 5.0. In an alternate embodiment, the mobile device is configured to operate on a JAVA platform or some other means on which a mobile device can operate. Thereafter, the truck driver captures a digital image of a freight seal in real time endorsed by a time stamp at shipment source 20, by means of mobile device 34 to confirm pickup of the appropriate shipment.

In the exemplary embodiment, monitoring 52 the shipment further includes tracking 74 a position of the shipment and loading 76 position information to server 30. For example, when the truck driver departs from shipment source 20 with the appropriate shipment, mobile device 34 performs the function of a global positioning system (GPS). In some embodiments, mobile device 34 is a personal digital assistant (PDA) based GPS reporting system. For example, the PDA based GPS reporting system may be a mobile device based on a bill of lading reporting system with a password protected bill of lading editing feature. An exemplary bill of lading reporting system may be based on Voluntary Interindustry Commerce Solutions (VICS) standards. With the PDA or mobile device, aspects of the invention provide the ability to make deliberate changes to a bill of lading in real time. The PDA based reporting system facilitates cost effective GPS reporting by being turned on and “pinging” cellular towers for triangulation, recording a location periodically (e.g., once every one minute), and then uploading the recorded information periodically (e.g., once every four hours) to database 32. In some embodiments, the GPS mechanism is configured to be inoperative during the loading and unloading processes, during which time mobile device 34 is configured to perform additional auditing functions in real time. In an alternate embodiment, the GPS mechanism is configured to simultaneously record the co-ordinates of any transit location while simultaneously performing additional auditing functions in real time.

Once the geographical coordinates of the shipment are determined by the GPS mobile device, the mobile device uploads 76 this data directly as GPS coordinates to the web portal in real time. Database 32 is configured to automatically receive information from mobile device 34 and to transmit information directly to mobile device 34 in real time.

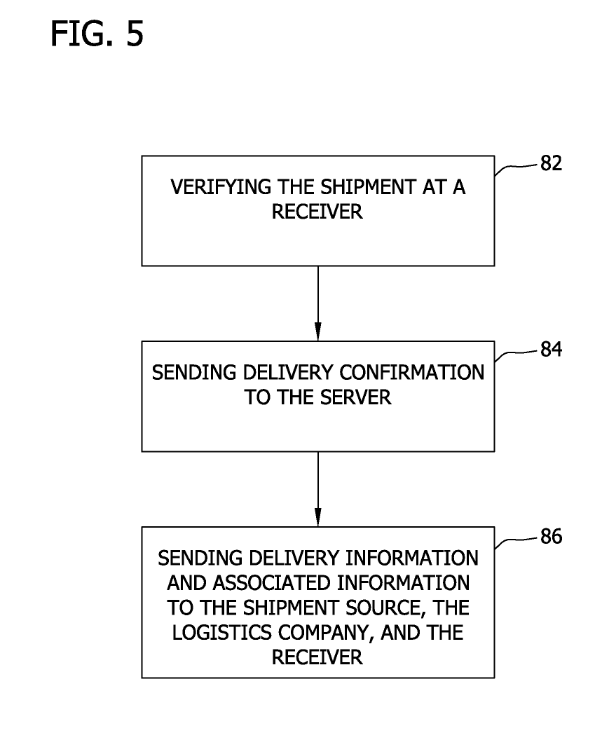

FIG. 5 is a flowchart of steps included in auditing 54 delivery of the shipment. In an exemplary embodiment, auditing 54 delivery of the shipment includes verifying 82 the shipment at receiver 22 (shown in FIG. 1) or other recipient at the time of delivery. For example, when the truck driver arrives at the location of the receiver 22, the driver establishes contact with server 30. Contact is established by logging into server 30 by means of mobile device 34 using the unique truck driver identification number, as discussed above. Once logged in, the truck driver captures a digital image, endorsed by a time stamp, of a freight seal before the seal is broken, by means of mobile device 34. Thereafter, the truck driver captures a digital image endorsed by the time stamp, of the freight seal after the seal is broken, by means of mobile device 34. The truck driver may also capture a digital image endorsed by the time stamp of the shipment as it is unloaded, while simultaneously recording the GPS location, to ensure that the shipment is unloaded at the location of receiver 22.

Mobile device 34 is further configured to compare the individual products delivered to receiver 22 with the bill of lading that is stored in the mobile device's memory in real time (or accessible from a remote memory area), as the products are being unloaded from the truck. In the exemplary embodiment, each item being unloaded is scanned using bar code scanner 36 (shown in FIG. 1) or is typed into the software using keypad 38 (shown in FIG. 1). The unloaded items are compared with the appropriate items on the bill of lading that is stored in the mobile device's memory. Comparing each unloaded item to the items on the bill of lading facilitates ensuring accurate auditing of the products that are delivered to receiver 22. Furthermore, mobile device 34 may be configured to record a count on the number of pallets that are being unloaded along with the contents of each pallet on a real time basis. Mobile device 34 may also be configured to receive inputs from the truck driver such as, but not limited to, item numbers, pallet identification numbers, and any other information that may be relevant to a given shipment. In addition, the truck driver may also enter information into mobile device 34 and/or capture digital images of products that have been damaged during the shipment and transit processes.

When the shipment has been fully unloaded, the truck driver prompts handheld mobile device 34 to “summarize” the shipment grouping. In an exemplary embodiment, summarizing the shipment grouping includes editing the bill of lading to reflect the actual goods delivered as well as the condition of the goods. More specifically, summarizing the shipment grouping may include summing up all products received, the product pallet numbers, and the quantity of products delivered on each pallet on a real time basis. Confirmed summaries are then shared between the truck driver and a responsible receiving party, to arrive on common agreeable terms pertaining to the products delivered in a given shipment.

In some embodiments, a notification is generated if the comparison between the edited bill of lading and the bill of lading from the logistics company 24 identifies discrepancies. For example, if one or more products are missing, the shipper may be notified of the missing products.

Auditing 54 may also include receiving a valid and validated signature, picture, and GPS location of a responsible receiving party, together with the title of the receiving party, using mobile device 34. Auditing 54 delivery of the shipment may also include sending 86 delivery confirmation to server 30, and sending 86 delivery information and associated information to the shipment source, the logistics company, and the receiver. For example, once verifying 82 is complete, the data recorded in the memory of mobile device 34 is authorized to be wirelessly transmitted to database 32 in real time, by the truck driver. Once the shipment confirmation has been received in the database, the shipment source, the logistics company, and the receiver are notified that the shipment has been made to the receiving party. In some embodiments, server 30 may contact shipment source 20, logistics company 24, and receiver 22 via communication channels such as telephone, e-mail, fax, or any other communication media through which server 30 may notify the individual parties that shipment has been made to the receiving party. Further, an invoice pertaining to the delivered shipment may be automatically generated by server 30 and transmitted to shipment source 20 instantaneously after product delivery confirmation, and a copy of the invoice may be simultaneously transmitted to the logistics company.

In addition, the data and images transmitted by mobile device 34 during the auditing process from the time the truck driver arrives at the receiver's location to the time that the truck driver disengages all responsibilities of a shipment, may be accessible by the respective parties in real time including the bill of lading containing the shipment number, the purchase order number(s), the planned shipment date, planned shipment time, the shipment identification number, the license plate or pallet identification number for each pallet, the product UPC and description for each pallet, the quantity in units of each item of each UPC on each pallet, the invoice numbers relative to each section of the shipment, the ship-to name, address and zip code. Shipment source 20, logistics company 24, and receiver 22 are each provided with a tracking entity that is associated with each planned shipment order to verify the real time status of the shipment. In some embodiments, the tracking entity may be a tracking number that is associated with each planned shipment order. In some alternative embodiments, all data and images transmitted by mobile device 34 during the auditing process to database 32, including the bill of lading, are transmitted by server 30 to shipment source 20, logistics company 24, and receiver 22 directly, on a real time basis, or in near real-time.

With the PDA system providing on-the-spot verification of a given container, a product status and all relevant information pertaining to a dispatched shipment, and auditing and transmitting the status of the shipment in real time, the accuracy and efficiency of the supply chain process between shipment source 20 and receiver 22 can be dramatically increased. In addition, invoicing may be performed instantaneously to shipment source 20 and logistics company 24 instantaneously when shipment has been made to receiver 22. This is at least because all information received by mobile device 34 and transmitted to database 32 is transmitted in real time. Moreover, auditing 54 facilitates receiver 22 being invoiced for only those products that were received without putting undue financial burden on receiver 22 for lost, stolen or damaged products. This ability provides logistics companies a unique opportunity to charge a service fee for a real time verified service to their shipment sources and associated logistics companies.

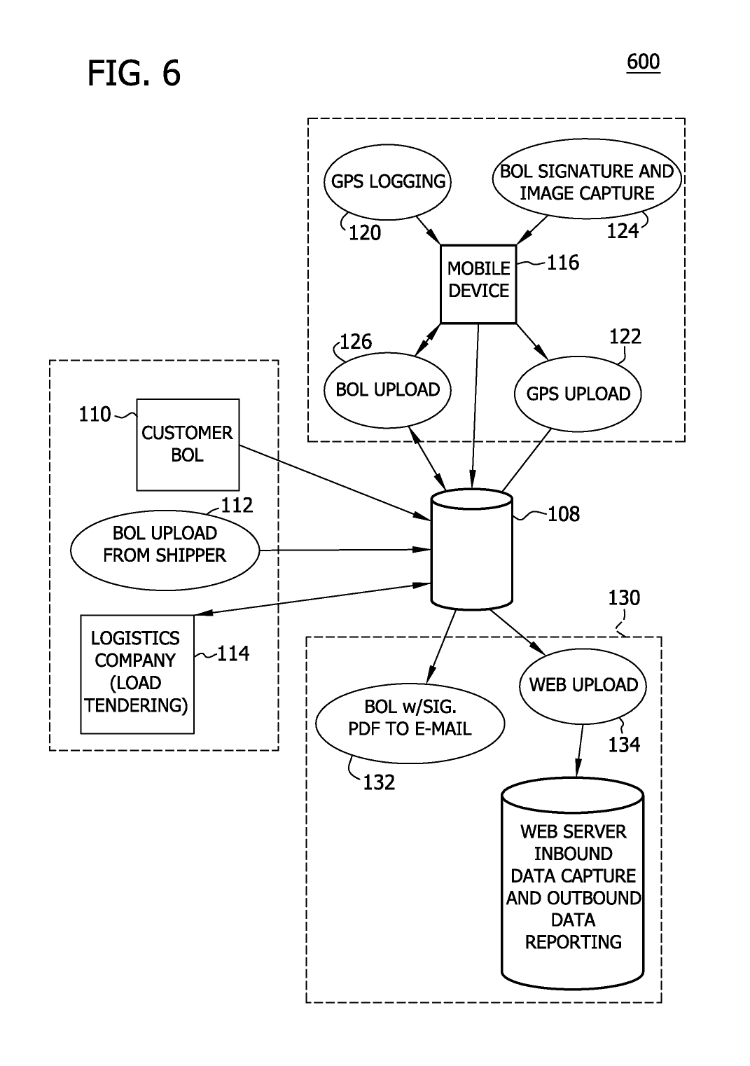

FIG. 6 is a block diagram 600 illustrating an exemplary flow of information during completion of a shipment using auditable tracking system 12 (shown in FIG. 1). In the exemplary embodiment, a server 108 is configured to receive 110 a request from a shipper to ship a plurality of goods. As described above, after the shipper requests a shipment, a logistics company is notified of the requested shipment. After receipt of the shipment notification by the logistics company, server 108 is also configured to receive 112 logistics information from the logistics company for the plurality of goods requested to be shipped. Server 108 is also configured to receive 114 from the shipper a bill of lading associated with the plurality of goods.

A mobile device 116 is configured to receive 120 GPS location information and upload 122 the GPS location information to server 108. As described above, receiving 120 GPS location information facilitates monitoring 52 the location of the shipment while in transit between shipping source 20 and receiver 22. Receiving 120 GPS location information also facilitates ensuring the shipment is unloaded at the receiver 22. Mobile device 116 is also configured to capture 124 images of the items delivered and authenticating signatures from personnel at receiver 22.

In an exemplary embodiment, mobile device 116 is also configured to enable a user to edit the bill of lading in response to an inspection by the user of the delivered goods and provide 126 the edited bill of lading to server 108. Server 108 is configured to receive from the logistics company data identifying the plurality of goods that were delivered. For example, server 180 is configured to receive from mobile device 116 a quantity of goods delivered. Furthermore, as described above, mobile device 116 and server 108 are configured to provide 130 the edited bill of lading to the shipper and the logistics company. In order to provide 130 the edited bill of lading to the shipper and the logistics company, server 108 may be configured to deliver 132 the edited bill of lading to predetermined e-mail addresses. Alternatively, or in combination with an e-mail message, server 108 may be configured to upload 134 the edited bill of lading to a web server to provide the shipper and the logistics company with web access to the edited bill of lading.

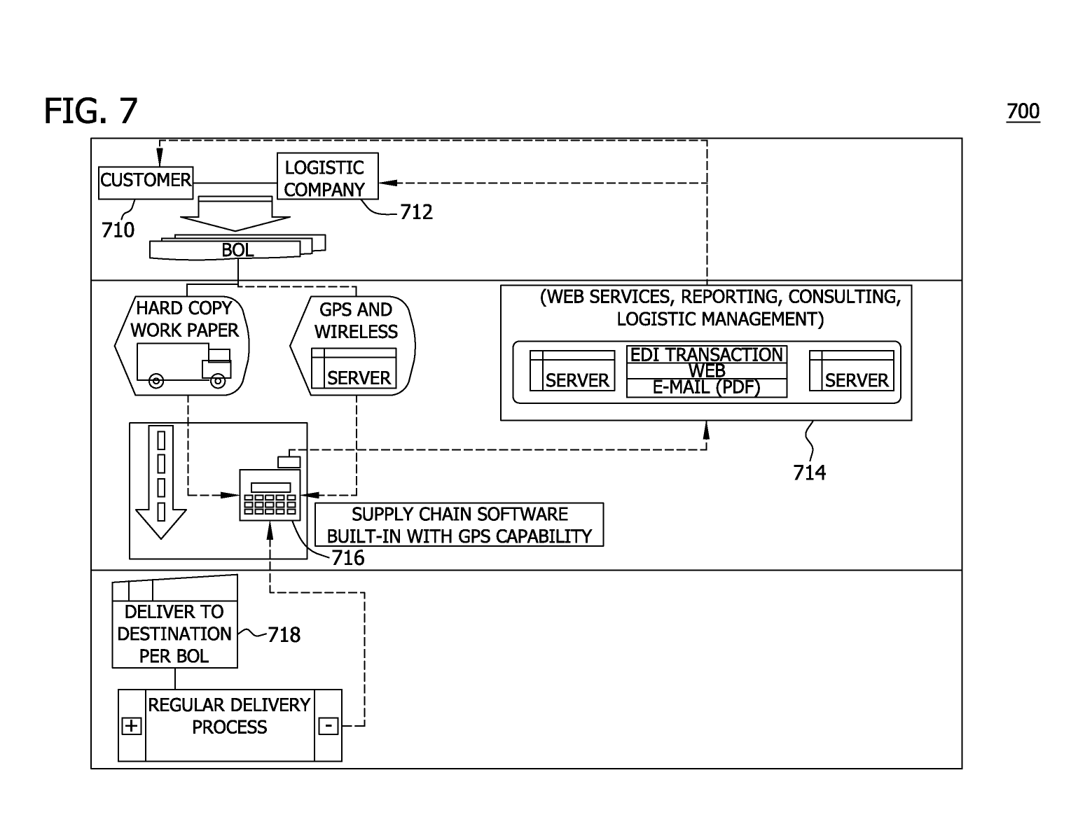

FIG. 7 is a block diagram 700 illustrating another exemplary flow of information during completion of a shipment using auditable tracking system 12 (shown in FIG. 1). A customer 710 and a logistics company 712 are in communication with a server 714. A mobile device 716 is also in communication with server 714. Server 714 and mobile device 716 are configured to provide auditable tracking of a shipment from customer 710 to a destination 718, as described above with respect to FIGS. 1-6.

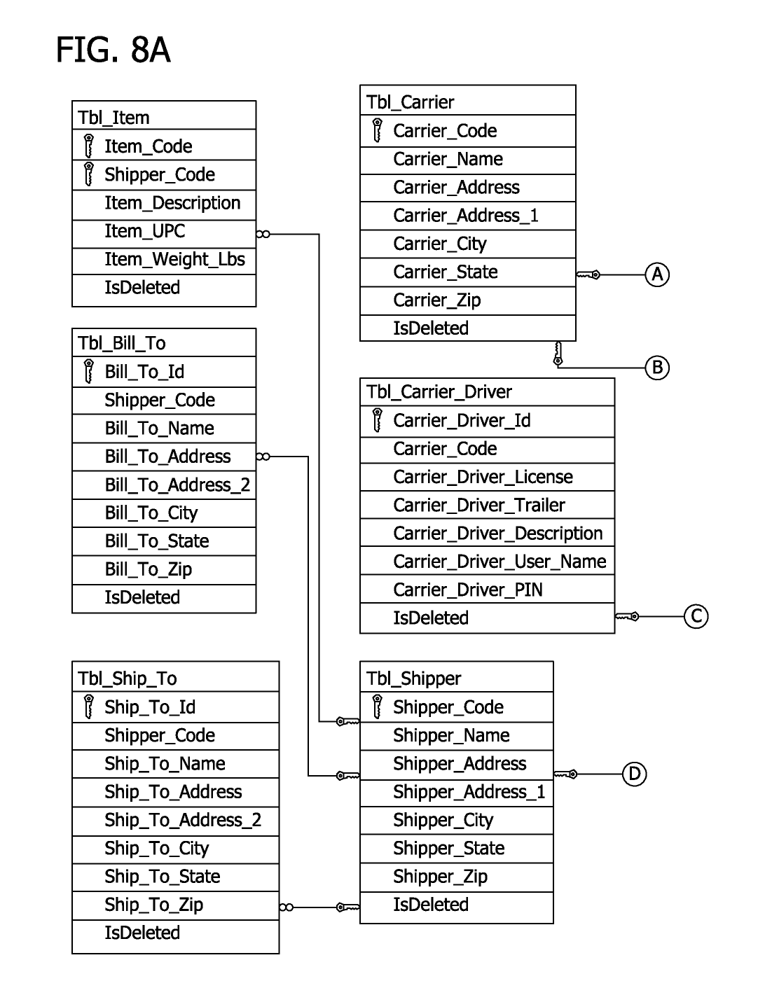

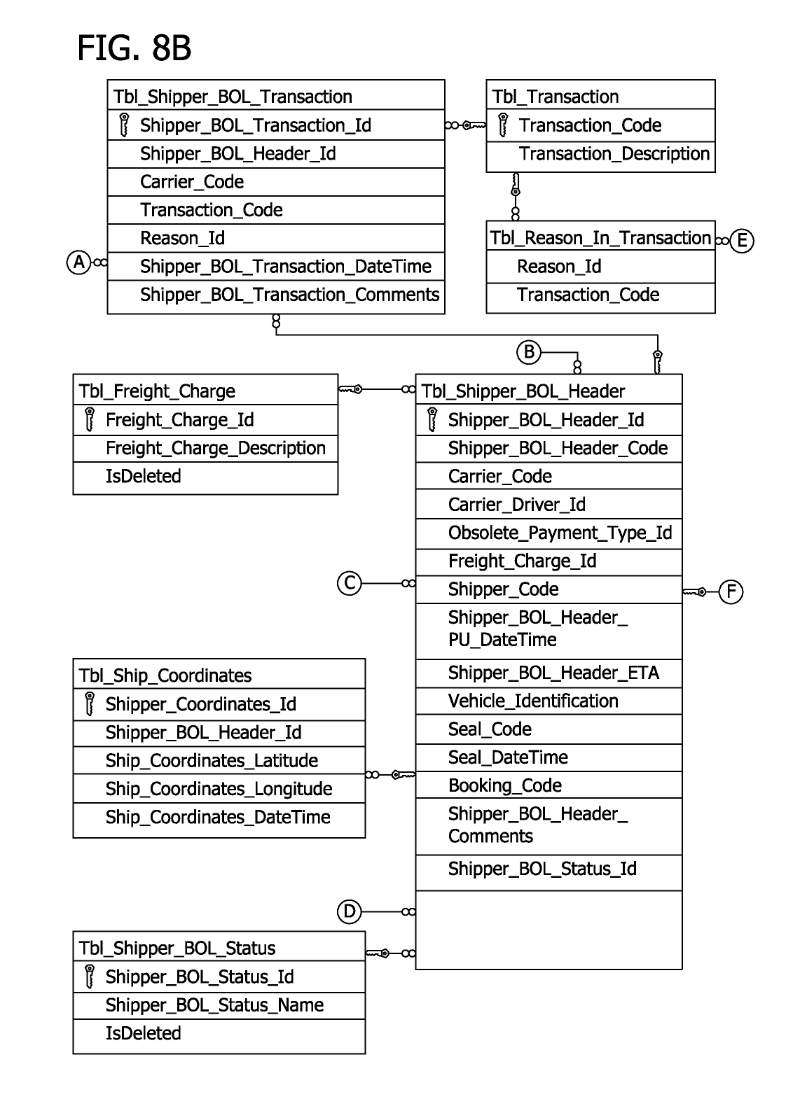

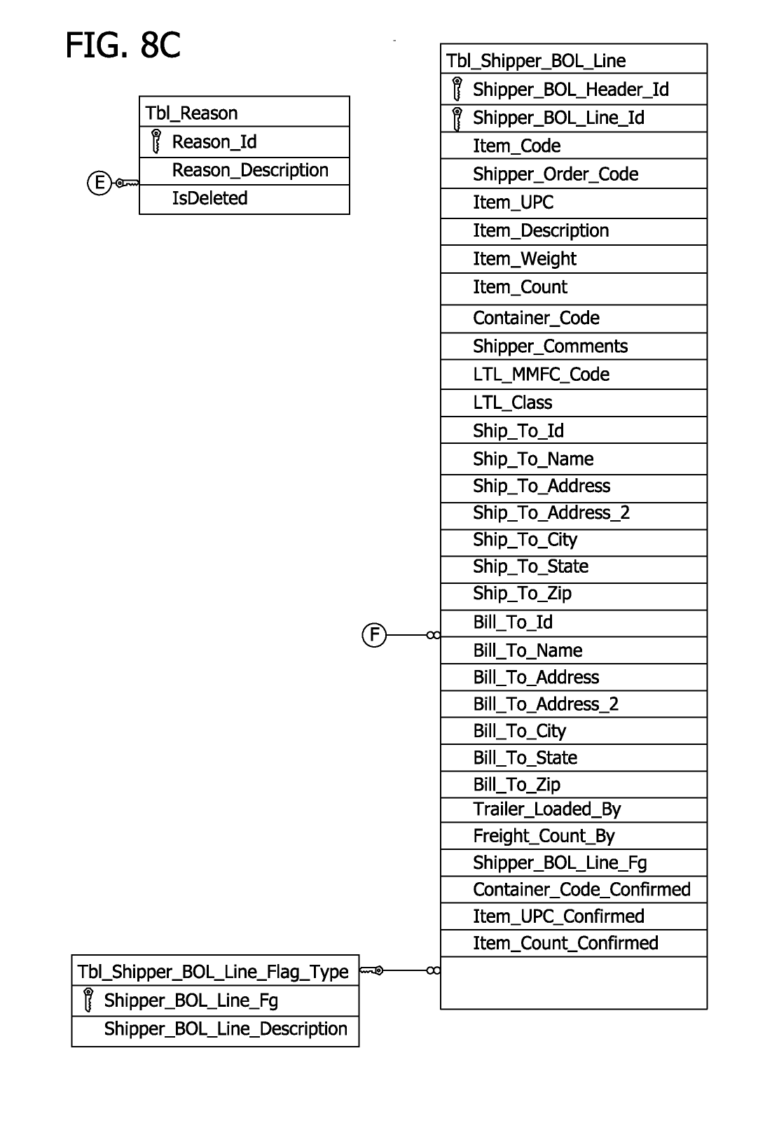

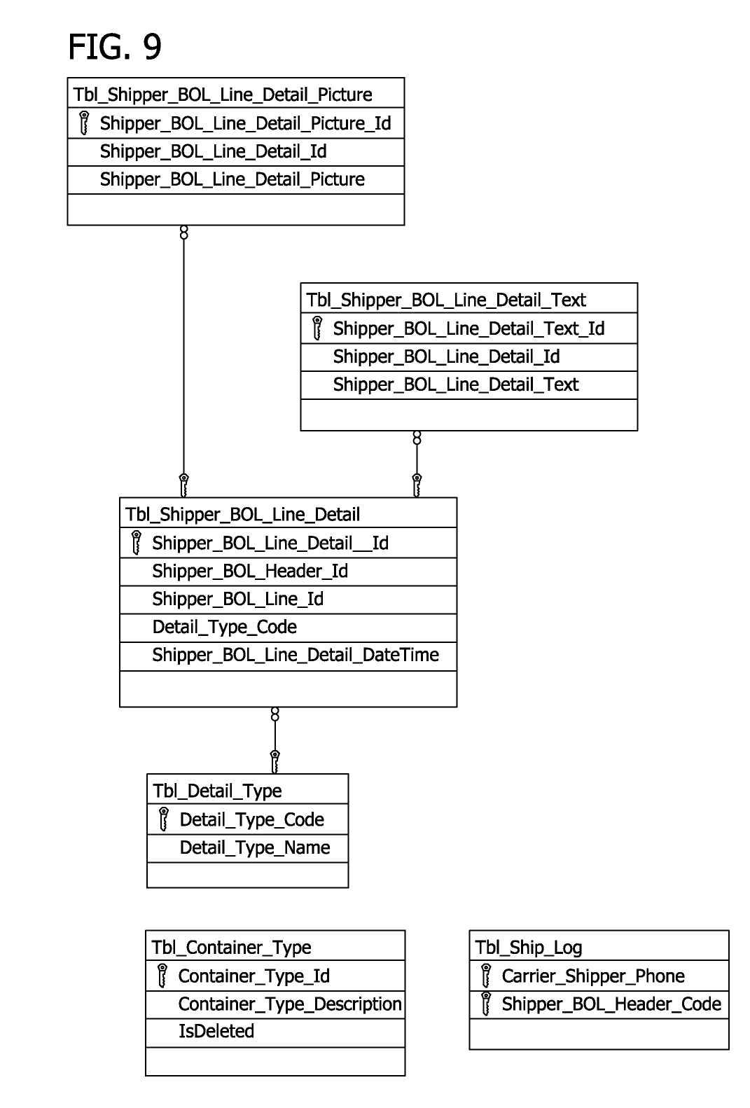

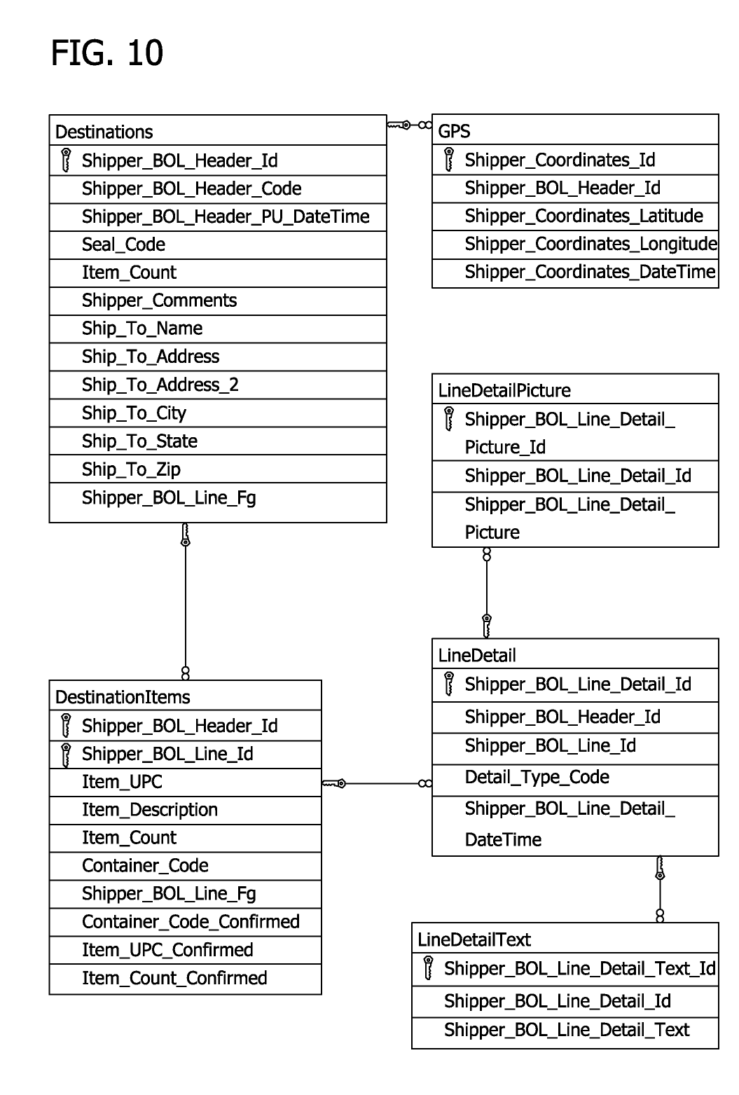

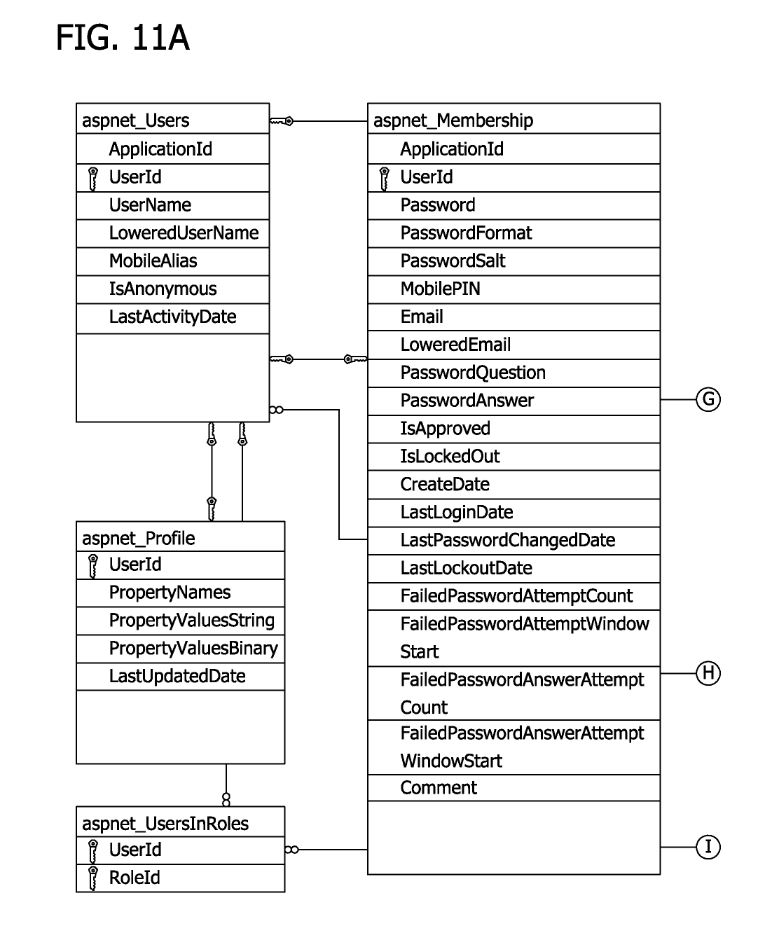

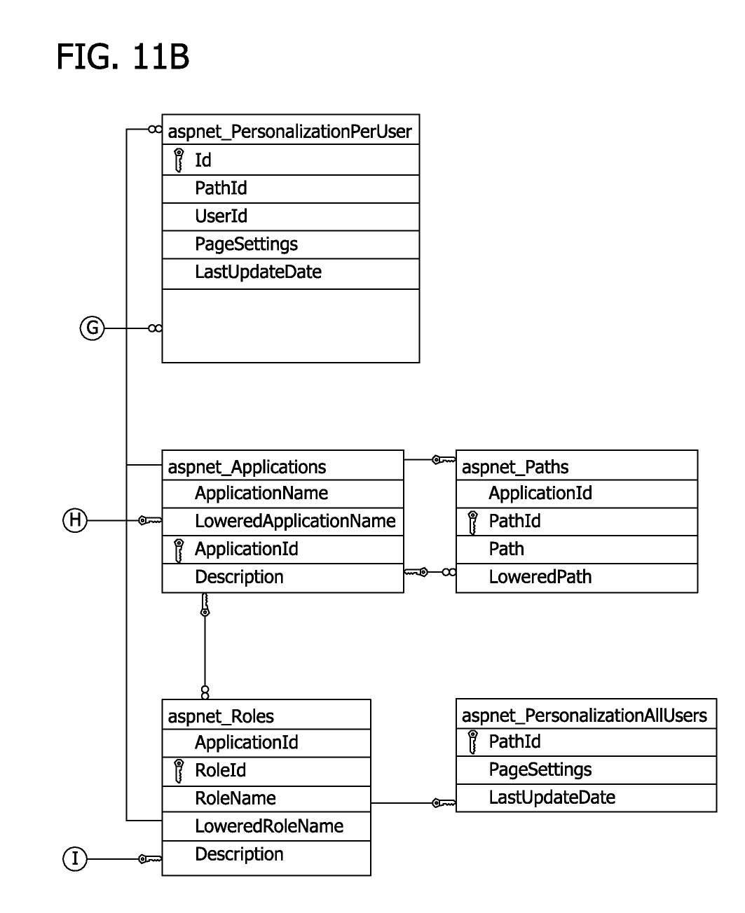

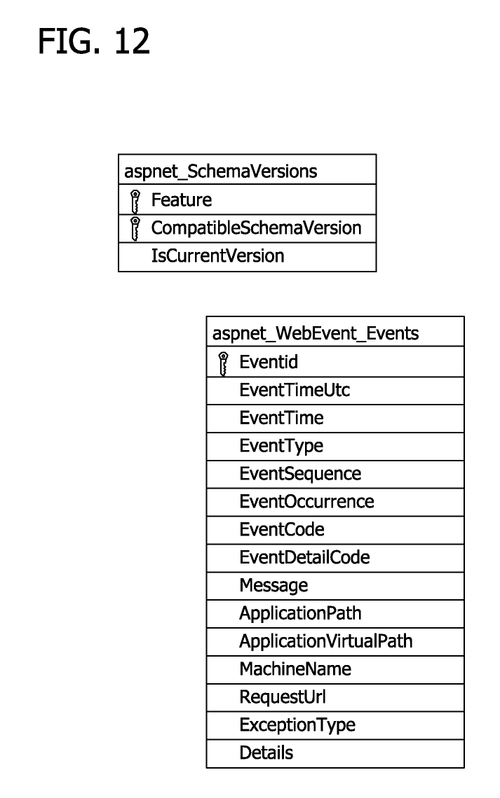

Referring next to FIGS. 8, 9, 10, 11, and 12, exemplary schemas illustrate data structures for storing data in a server in an embodiment of the invention.

As described herein, a computing device or computer may have one or more processors or processing units and a system memory. The computer typically has at least some form of computer readable media. Computer readable media, which include both volatile and nonvolatile media, removable and non-removable medium, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory includes computer storage media in the form of removable and/or non-removable, volatile and/or nonvolatile memory. The computer may operate in a networked environment using logical connections to one or more remote computers, such as a remote computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

In operation, a computer executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for auditable tracking of a shipment, said method comprising:
receiving a request from a shipper to ship a plurality of goods;
receiving logistics information from a logistics company in response to the request from the shipper;
receiving from the shipper a bill of lading associated with the plurality of goods;
subsequently, receiving from the logistics company data identifying a quantity of the plurality of goods delivered;
receiving an edited bill of lading, said received bill of lading being edited by a recipient responsive to an inspection by the recipient of the delivered plurality of goods; and
analyzing the received logistics information, the received bill of lading, the received data identifying the quantity of the plurality of goods delivered, and the received edited bill of lading.

2. A method in accordance with claim 1, wherein the information included in the bill of lading corresponds to the plurality of goods.

3. A method in accordance with claim 1, wherein receiving the edited bill of lading comprises receiving at least one of recipient entered delivery information and delivery information entered using a scanning device.

4. A method in accordance with claim 3, wherein the delivery information includes at least one of an item number and a pallet identification number.

5. A method in accordance with claim 1, further comprising comparing the edited bill of lading to the bill of lading received from the shipper.

6. A method in accordance with claim 5, further comprising generating a notification based on said comparing.

7. A method in accordance with claim 1, further comprising receiving, upon delivery, information on damage to one or more of the plurality of goods.

8. A method in accordance with claim 1, wherein a mobile device accessible by the recipient at the time of delivery captures at least one of a digital image of an unbroken freight seal and a digital image of the freight seal after being broken, wherein the at least one digital image includes a time stamp.

9. A method in accordance with claim 1, further comprising receiving location information for the recipient.

10. A method in accordance with claim 1, wherein a mobile device accessible by the recipient at the time of delivery captures a digital image endorsed by a time stamp of the shipment as the shipment is unloaded, while simultaneously recording a location to facilitate ensuring that the shipment is unloaded at a predetermined location.

11. A method in accordance with claim 1, wherein receiving a request from the shipper to ship the plurality of goods comprises receiving at least one of shipment source information, actual shipment information, and shipment order information.

12. An auditable tracking system comprising:
a server configured to:
receive a request from a shipper to ship a plurality of goods;
receive a confirmation from a logistics company accepting the shipment request; and
receive a bill of lading from the shipper; and
a mobile device configured to:
receive information corresponding to receipt of the plurality of goods at a delivery destination;
edit the bill of lading in accordance with the information corresponding to receipt of the plurality of goods at the delivery destination; and
provide the edited bill of lading to said server, the shipper, and the logistics company.

13. A system in accordance with claim 12, wherein said mobile device is further configured to compare the received bill of lading from the shipper to the received information corresponding to receipt of the plurality of goods at the delivery destination.

14. A system in accordance with claim 12, wherein said mobile device is configured to receive information corresponding to receipt of the plurality of goods at the delivery destination, wherein the information comprises at least one of an item number, a pallet identification number, and a condition of the item.

15. A system in accordance with claim 12, wherein the bill of lading comprises at least one of a packaging list and an electronic data interchange (EDI) message.

16. A system in accordance with claim 12, wherein the bill of lading comprises at least one of a shipment number, a purchase order number, a planned shipment date, a planned shipment time, a shipment identification number, a pallet identification number for each pallet, a product UPC and description for each pallet, a quantity in units of each item of each UPC on each pallet, invoice numbers relative to each section of the shipment, a ship-to name, a ship-to address, and a zip code.

17. A system in accordance with claim 12, wherein said mobile device is configured to capture a digital image of at least one of a freight seal and damage to the plurality of goods.

18. A system in accordance with claim 12, wherein said mobile device is configured to receive position information and transmit the position information to said server.

19. A system in accordance with claim 18, wherein said mobile device is configured to receive position information from at least one of triangulation of cellular towers and global positioning system (GPS) satellites.

20. A system in accordance with claim 18, wherein said mobile device is further configured to capture a digital image endorsed by a time stamp of the shipment as it is unloaded, while simultaneously recording a location to facilitate ensuring that the shipment is unloaded at a predetermined location.
